(19) United States
(12) Patent Application Publication
(10) Pub. No.: US 2004/0179924 A1
(43) Pub. Date: Sep. 16, 2004

(54) Robotic package unloading machine

(76) Inventors: Robert Dana Lundahl, Frederick, MD (US); Robert Wesley Cutlip, Millersville, MD (US)

Correspondence Address: Hung Chang LIN, 8 Schindler Ct., Silver Spring, MD, 20903, US

(21) Appl. No.: 10/796,319

(22) Filed: Mar. 10, 2004

Related U.S. Application Data
(60) Provisional application No. 60/453,158, filed on Mar. 11, 2003.

(51) Int. Cl. B65G 65/04

(52) U.S. Cl. 414/416.01

(57) ABSTRACT

This invention presents a design for a robotic unloading system that could be used to unload packages from containers. In the basic configuration, a robotic manipulator is coupled with a vision or sensor system and powered conveyor belt. The robot and vision system are used to identify packages and determine presence and orientation. A conveyor belt is positioned in close proximity to the package being removed. The robot and EOAT are used to move the package only a short distance to where the conveyor belt catches the product and carries it away. The greatly simplifies the system design since the robot does not need the precision to securely lift and carry the package. The robot only needs to move the package onto the conveyor that is actively and advantageously positioned for each package removal action. The robot and conveyor work together to simplify the unloading process. The robot is only used to move product onto the conveyor.

### BACKGROUND OF THE INVENTION

1. Field of the Invention

The invention relates to package unloading machine, particularly to a robotic package unloading machine for unloading non-uniform and non-structured bulk packages.

2. Brief Description of Related Art.

There are many applications in general field of material handling where individual items must be unloaded from a larger unit holding multiple items. Common examples would include unloading packages from a pallet, unloading packages from inside a shipping container, picking items from a bin, or removing items from a case.

This “picking” process can be very labor intensive, and frequently it is the only manual process in an otherwise automated material handling system. Several efforts have been made to use Robotic type manipulators to perform the picking process and there has been some success in specific applications. The cost and complexity of these systems can vary widely. The mix of product and the level of organization in the bulk packaging are key factors.

Simpler solutions can be applied to situations where the product is uniform and where it is precisely located and organized within the bulk package. In these cases the robot can be pre-programmed to move to specific places and the robot end-of-arm-tooling (EOAT) can be designed to grip the product in a very predictable manner. These solutions are less complex and less expensive.

More complex solutions are needed when the product is not uniform and where its orientation or even its presence is unknown. In these cases the robotic manipulator needs to be highly adaptable. The system will be required to determine the presence and orientation and perhaps differentiate between different types of packages. This can be attempted with a combination of sensors, processing power, and software algorithms. Sensors systems such as vision, structured light, 3 dimensional imaging, sonic distance measuring, etc. can be used to collect data which is processed to attempt to determine the location, identity, and orientation of packages. Then the manipulator is controlled to reach the package and grip it with the EOAT. This tooling must also be more complex since it is required to securely grip different packages, in unique orientations, in an unpredictable manner. These types of solutions can be very complex, expensive, and frequently not possible with conventional technology.

### SUMMARY OF THE INVENTION

An object of this invention is to implement a robotic unloading system where a combination of active mechanical components simplifies the technical requirements for unloading non-uniform and non-structured bulk packages. Another object of this invention is to solve the unloading problems [can be accomplished] with a simpler, less complex, and less expensive machine.

These objects are accomplished by utilizing standard mechanical components in a way that greatly simplifies the complexity of performing an automatic package unloading system. The use of a movable takeaway conveyor in coordination with the dynamic positioning of the robot manipulator allows the used of a simpler end-of-arm tool and package acquisition strategy. Packages do not have to be lifted or held, they can simply be dragged or pushed onto the takeaway conveyor. Great precision is not required for either path planning or package gripping. Processing speed is also enhanced since the manipulator does not carry the package for a distance. Robot moves are limited to relatively small area with the actual transport of packages being performed by the conveyor. Different products, mixtures, or configurations can be accommodated with updates to the software based algorithms.

### BRIEF DESCRIPTION OF THE DRAWING

FIG. 1 shows the robotic unloading system of the present invention.

### DETAILED DESCRIPTION OF THE INVENTION

In the basic configuration, a robotic manipulator is coupled with a vision or sensor system and powered conveyor belt. The robot and vision system are used to identify packages and determine presence and orientation. A conveyor belt is positioned in close proximity to the package being removed. The robot and EOAT are used to move the package only a short distance to where the conveyor belt catches the product and carries it away. This greatly simplifies the system design since the robot does not need the precision to securely lift and carry the package. The robot only needs to move the package onto the conveyor that is actively and advantageously positioned for each package removal action. The robot and conveyor work together to simplify the unloading process. The robot is only used to move product onto the conveyor.

Many different implementations of the basic configuration are possible and anticipated. The following sections show how this approach can be applied to a real-world unloading application typical of what is performed by Postal Mail Handlers when they unload mail trays from mail transport containers.

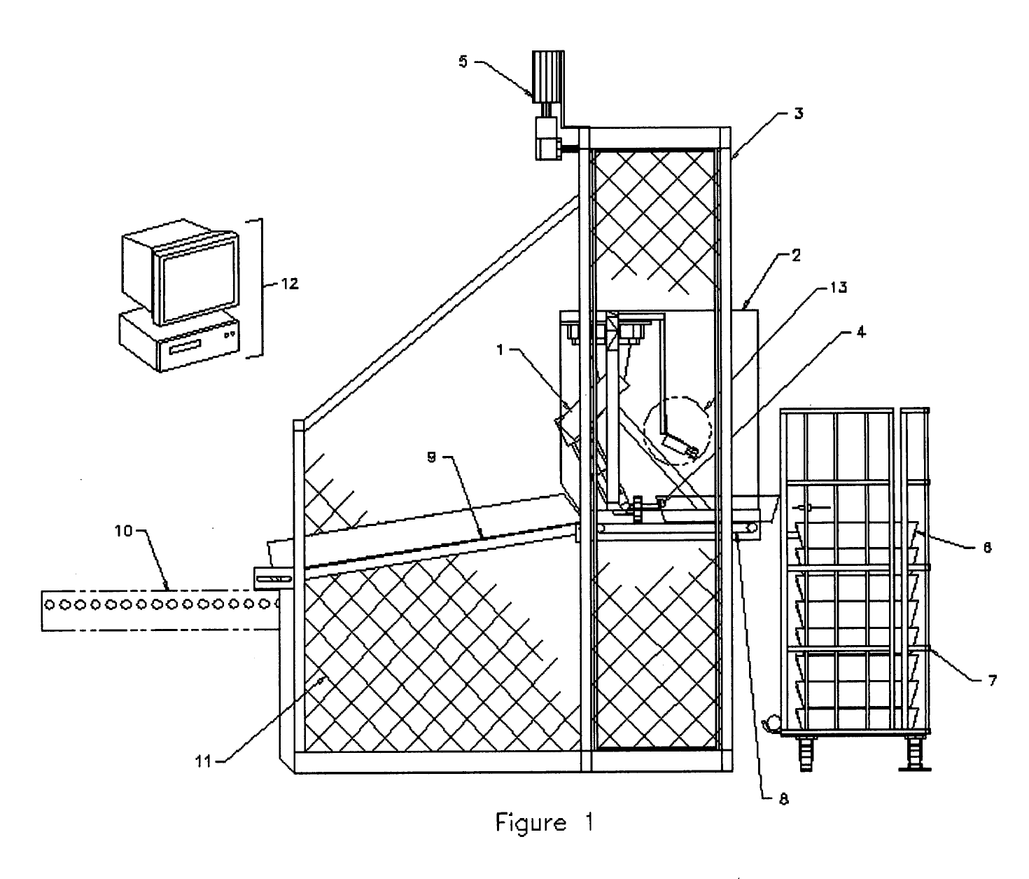

FIG. 1 illustrates one embodiment of the robotic unloading system. The robotic manipulator 1 is mounted in a carriage 2 which can be raised or lowered in the carriage lift frame 3. The robot is equipped with an end-of-arm tool 4, which is designed to grip the type of packages expected. The motor and drive mechanism 5 of the carriage lift frame provides the motive power to position the carriage at the correct height for unloading packages 6 from container 7.

The moving carriage incorporates a short takeaway conveyor belt 8, which moves with the carriage. Connected to the short takeaway belt is an articulating belt conveyor 9, which is connected to the moving carriage on one end and connected to the fixed take away conveyor 10 on the other end. The articulating belt conveyor could alternately be any variety of try transport technology including powered roller conveyor or simple slide. The entire unloading mechanism is protected with a safety enclosure (11) to protect surrounding personnel from the moving equipment. A computer 12 provides the processing power to control the robot, the lift mechanisms, and the image/sensors 13 used to identify and locate packages inside the containers.

In operation the container 7 is positioned in front of the automated unloading system. Positioning [could] can be manual or there can be some type of container feed system for automatic induction to the process. Once positioned, the carriage 2 raises in the carriage lift frame 3 and a image/sensor system 13 scans the container contents. A computer processor 12 uses a processing algorithm to interpret the sensor data and determines the location of packages for unloading. The carriage lift drive system 5 moves the carriage to a appropriate elevation where the self contained takeaway belt 8 is positioned just below the package layer. The processor 12 provides the robot manipulator with position and path data so that it can activate its arm movement and grip the package with a variety of preprogrammed strategies. The robot acquires the package with its end-of-arm-tooling 4 and pulls the package outwards until it makes contact with the takeaway belt 8. Once the package makes contact with the takeaway belt, the robot releases the package and let it be carried away to the articulating belt 9 which in turn carries the package to the fixed takeaway conveyor 10 of the facility material handling system. Operations without takeaway conveyors could deposit the package directly into another cart or container for subsequent processing

Having completed the removal of all packages on a single layer, the carriage lowers until new packages are sensed by the sensor system. Once there, position is determined by the processor and the robotic process is repeated. This sequence is repeated until all layers of the container are unloaded and the container is empty. Then the operators positions a new container or an automated feed system indexes a new container into position for automatic unloading

Conclusion

The design of this unloading system utilizes standard mechanical components in a way the greatly simplifies the potential complexity of performing an automatic package unloading system.

The use of a movable takeaway conveyor in coordination with the dynamic positioning of the robot manipulator allows the use of a simpler end of arm tool and package acquisition strategy. Packages do not have to be lifted or held, they can be simply dragged or pushed onto the takeaway conveyor. Great precision is not required for either path planning or package gripping. Processing speed is also enhanced since the manipulator does not carry the package any distance. Robot moves are limited to a relatively small area with the actual transport of packages being performed by the conveyor. Different products, mixtures, or configurations can be accommodated with updates to the software based algorithms.

Many variations of this basic design and geometry are possible and anticipated. However the basic configuration and process described in this invention can provide a robust and cost effective solution to a great variety of automated unloading applications. While a carriage and a lift are described in FIG. 1, the robotic manipulator need not be limited to be mounted and moved on a carriage/lift system.

While the preferred embodiment of this invention has been described, it will be apparent to those skilled in the art that various modifications may be made in the embodiment without departing from the spirit of the present invention. Such modifications are all within the scope of this invention.

1. A robotic package unloading system for unloading uniform as well as non-uniform and non-structured bulk packages, comprising:
a container for holding at least one package;
a robotic manipulator, wherein an end-of-arm tool is used to grip said package;
a takeaway conveyor for moving said package,
conveying means which is actively positioned to engage the package at one end and to be connected to said takeaway conveyor at second end;
an image/sensor to identify and locate said package in said container; and
a computer to control and process said robotic manipulator, said articulating belt and said image/sensor.

2. The robotic package loading system as described in claim 1, wherein said conveying means is an articulating belt

3. The robotic package unloading system as described in claim wherein said conveying means is a slide.

4. The robotic package unloading system as described in claim 1, further comprising:
a carriage for mounting said robotic manipulator;
a carriage lift frame along which the carriage can move up and down; and
a lift mechanism to position said carriage at a correct height for unloading said package.

5. The robotic package unloading system as described in claim 1, wherein said container is selected from the group consisting of a pallet, a bin and a case.

6. The robotic package unloading system as described in claim 1, wherein said package is selected from the group consisting of uniform and non-uniform and non-structured bulk.

7. The robotic package unloading system as described in claim 1, further comprising a safety enclosure to protect surrounding personnel.

8. The robotic package unloading system as described in claim 1, wherein said computer is used to process an algorithm to interpret the image sensor data and determine the location of packages for unloading.

9. The robotic package unloading system as described in claim 8, wherein the computer provides the robot manipulator with position and path data so that the robot manipulator grips the package with a variety of preprogrammed strategies.

10. A method of unloading uniform as well as non-uniform and non-structured bulk packages from a container, comprising the steps of:
holding a package in a container;
gripping said package with a robotic manipulator having an end-of-arm tool;
moving said package with a short takeaway conveyor belt;
connecting said carriage with said takeaway belt;
identifying and locating said package in said container with an image sensor; and
controlling and processing said robotic manipulator, said lift mechanism and said image sensor with a computer.

11. The method of unloading as described in claim 10, further comprising after the step of gripping the steps of:
mounting said robotic manipulator in a carriage frame so that the robotic manipulator can move up and down; and
lifting said carriage to position said carriage at a correct height for unloading said package with a lift mechanism.

12. The method of unloading as described in claim 10, wherein said package is pulled outwards until the package makes contact with the takeaway conveying belt, and once the package makes contact with the takeaway belt, the robot manipulator releases the package and let the package be carried away to the articulating belt, which in turn carries the package to the fixed takeaway conveyor.

13. The method of unloading as described in claim 11, further comprising a step of lowering said carriage after completing unloading all packages on a single layer until new packages are sensed by said image sensor.

14. The method of unloading as described in claim 13, further comprising a step of repeating said steps until all layers of the container are unloaded and the container is empty.

15. The method of unloading as described in claim 13, further comprising a step of positioning a new container by an operator into positioning for automatic unloading system.
